(19) United States
(12) Patent Application Publication
(10) Pub. No.: US 2001/0050359 A1
(43) Pub. Date: Dec. 13, 2001

(54) Garage jack

(75) Inventors: Hiroyoshi Tominaga, Tokyo (JP); Yaichi Sawai, Tokyo (JP); Hisashi Asano, Tokyo (JP)

Correspondence Address: SUGHRUE, MION, ZINN, MACPEAK & SEAS, 2100 Pennsylvania Avenue, N.W., Washington, DC, 20037, US

(73) Assignee: MASADA SEISAKUSHO CO., LTD.

(21) Appl. No.: 09/866,654

(22) Filed: May 30, 2001

(30) Foreign Application Priority Data
Jun. 12, 2000 (JP) 2000-175038
Nov. 2, 2000 (JP) 2000-336319

(51) Int. Cl. B66F 3/00

(52) U.S. Cl. 254/8 B

(57) ABSTRACT

The present invention provides a garage jack having satisfactory operating characteristics, in which an arm provided with a support plate may be rapidly operated in a substantially no-load operation of raising a support plate from its lowest height to a jack point, and in which an output to lift an object may be easily obtained when there is a load operation. The garage jack includes, a frame provided with movable wheels, an arm pivotably supported at the frame and having a support plate at an end thereof, a hydraulic cylinder for operating the arm up-and-down, a pump cylinder for supplying hydraulic fluid to the hydraulic cylinder and a handle for operating the pump cylinder wherein, the hydraulic cylinder comprises a dual cylinder mechanism comprising a low pressure chamber of a small effective cross-sectional area relative to a piston and a high pressure chamber of a large effective cross-sectional area, and a first pump cylinder for feeding hydraulic fluid to the low pressure chamber and a first hydraulic fluid channel thereof, and a second pump cylinder for feeding hydraulic fluid to the high pressure chamber and a second hydraulic fluid channel thereof, are provided independently.

### BACKGROUND OF THE INVENTION

(a) Field of the Invention

The present invention relates to a garage jack used for raising and lowering automotive vehicles such as passenger cars and trucks when performing maintenance or repair at a maintenance shop or gasoline stand, and, in particular to a garage jack including a movable frame equipped with wheels, an arm pivotably supported at the frame and having a support plate at an end thereof and a hydraulic cylinder for operating the arm up-and-down, a pump cylinder for supplying hydraulic fluid to the hydraulic cylinder and a handle for operating the pump cylinder.

(b) Description of the Related Art

Conventionally, in this type of garage jack the support plate is properly set to a jack point (for example, a differential, axle, etc.) located at the underside of an automotive vehicle and the arm is operated up-and-down to raise or lower the vehicle. Moreover, in order for the support plate to contact the jack point of the vehicle, it is necessary to slide the frame of the garage jack beneath the vehicle and position the support plate directly underneath the jack point.

As can be seen in FIGS. 2 and 3, a conventional garage jack such as above includes a movable frame 1 equipped with wheels 2, an arm 5 supported at the frame by means of a pivot 3 and having a support plate 4 at an end thereof, a link rod 6 for assisting actuation of the arm 5 pivotably attached to the frame 1, a hydraulic cylinder 9 provided with a piston rod 8 of which a tip is connected to a base 7 of the arm 5, a pump cylinder 10 for supplying hydraulic fluid to the hydraulic cylinder 9 and a manual handle 13 for operating the pump cylinder 10 via links 11, 12. In this type of garage jack, the pump cylinder 10 is operated by manipulating the handle 13 and the hydraulic cylinder 9 is operated by means of hydraulic fluid from the pump cylinder 10, and the arm 5 is raised to raise the support plate 4.

As can be seen in FIG. 2, a garage jack in which the arm 5, link rod 6 and hydraulic cylinder 9 are arranged in-line horizontally so that it may be used even on cars that are very low to the ground is disclosed in Japanese Patent Application Laid-open No. Hei 10-33090.

Also, as shown in FIG. 3, a structure is also already known from Japanese Patent Application Laid-open No. Hei 10-33090 in which it is possible to dispose hydraulic cylinder 9 below the arm 5 by operating the arm 5 through a link 14 provided between the arm 5 provided with a support plate 4 at an end thereof and the piston 8.

In garage jacks such as above, the height of the garage jack is limited by the ground clearance of automotive vehicles because the frame is slid underneath the vehicle for use. Accordingly, because of this height limitation, it is very difficult to increase the output of a garage jack by increasing the diameter of the hydraulic cylinder.

Thus, in this type of garage jack, efforts have been made to increase the pressure inside the hydraulic cylinder in order to obtain a large output. However, it is necessary to prevent the diameter of the pump cylinder from being small because the pump cylinder is operated by human power by means of a manually-operated or foot-operated handle, and the operating frequency of the pump piston will increase remarkably when employing this high pressure means.

Incidentally, since a load on the garage jack is merely the load of the arm as it raises from a lowest height of the support plate of the garage jack to the vehicle jack point, and this may be substantially ignored, the output of the hydraulic cylinder may be very low. That is, since the operation of raising the arm from the lowest height of the support plate to the jack point is not the originally intended use of the garage jack, namely, lifting an automotive vehicle, but is supplementary thereto, increasing the pump cylinder's frequency of operation reduces the convenience of the garage jack.

A garage jack has already been proposed in which, as a method of eliminating inconvenience in the substantially no-load operation of raising the support plate from its lowest height to the jack point caused by the increased frequency of manual operation of the pump cylinder, a foot-operated pedal as a secondary handle is added to substitute operation by means of the foot-operated handle for operation by a handle when there is a substantially no-load operation in order to reduce the manual operating frequency of the pump cylinder.

That is to say, as regards garage jacks, normally, in order to manually operate the handle to work the pump cylinder, efforts to increase the pressure in the hydraulic cylinder have been to increase a length from a pivot point of the handle to an operating portion and thereby increase the operating force of the pump cylinder in accordance with the principle of the lever. Nevertheless, since the pressure in the hydraulic cylinder may be low during the substantially no-load operation of raising the support plate from its lowest height to the vehicle jack point, operating a long handle is not reasonable. As shown in FIGS. 4 and 5, a garage jack has been proposed equipped with a long handle 13 of a length L2 from a pivot point 15 to an operating portion 16a and short handle, that is a foot-operated pedal 17, of a length L1 as a method for eliminating this irrationality.

In garage jacks such as above, when working the foot-operated pedal 17 having the length L1 from the pivot 15 to the operating portion 16b, operation is facilitated because the amount the foot-operated pedal moves is small. However, unless the effective cross-sectional area of the hydraulic fluid piston 8 is changed, an amount discharged by the pump cylinder 10 when worked one time by the long manually-operated handle 13 is the same as that discharged by the pump cylinder when worked one time by the short foot-operated handle. Accordingly, the speed of the piston 8 is the same and foot operation is merely substituted for manual operation. Hence, the problem of reduced convenience is not really eliminated with this sort of means.

### SUMMARY OF THE INVENTION

The present invention aims to solve the above problems with the conventional art and an object of the present invention is to provide a garage jack having satisfactory operating characteristics, in which a support plate may rapidly arrive at a jack point from its lowest position, and in which an object to be lifted by an output of a hydraulic cylinder may be easily lifted into position by using a dual cylinder mechanism provided with a rapid traverse function in order to eliminate inconvenience in the substantially no-load operation of raising the support plate from its lowest height to the jack point caused by increased frequency of manual operation of the pump cylinder.

According to one aspect of the present invention there is provided a garage jack comprising,

a movable frame provided with wheels, an arm pivotably supported at the frame and having a support plate at an end thereof, a hydraulic cylinder for operating the arm up-and-down, a pump cylinder for supplying hydraulic fluid to the hydraulic cylinder and a handle for operating the pump cylinder wherein,

the hydraulic cylinder includes a dual cylinder mechanism including a low pressure chamber of a small effective cross-sectional area relative to a piston and a high pressure chamber of a large effective cross-sectional area, and a first pump cylinder for feeding hydraulic fluid to the low pressure chamber and a first hydraulic fluid channel thereof, and a second pump cylinder for feeding hydraulic fluid to the high pressure chamber and a second hydraulic fluid channel thereof, are provided independently.

According to another aspect of the present invention there is provided a garage jack wherein,

a fourth hydraulic fluid channel provided with a check valve and connected to the first hydraulic fluid channel of the first pump cylinder is preferably provided at the second hydraulic fluid channel of the second pump cylinder in order to feed hydraulic fluid from the second pump cylinder to the low pressure chamber, and, a third hydraulic fluid channel provided with a check valve is preferably provided between the high pressure chamber and an oil tank to prevent a vacuum in the high pressure chamber.

According to yet another aspect of the present invention there is provided a garage jack wherein,

a hydraulic fluid channel provided with a relief valve is preferably provided connected to the first and second hydraulic fluid channels to return hydraulic fluid to the oil tank, and, the first pump cylinder is preferably provided with a short foot-operated handle, and the second pump cylinder is preferably provided with a long manually-operated handle.

### BRIEF DESCRIPTION OF THE DRAWINGS

FIG. 1 is circuit diagram showing a hydraulic circuit of a garage jack according to the present invention.

FIG. 2 is an explanatory drawing of a conventional garage jack.

FIG. 3 is an explanatory drawing of another conventional garage jack.

FIG. 4 is an explanatory drawing of yet another conventional garage jack.

FIG. 5 is circuit diagram of a hydraulic circuit of the garage jack shown in FIG. 4.

### DETAILED DESCRIPTION OF THE PREFERRED EMBODIMENTS

Preferred embodiments of the garage jack of the present invention will be described below with reference to the drawings. Moreover, similar or corresponding portions are denoted by the same reference numerals.

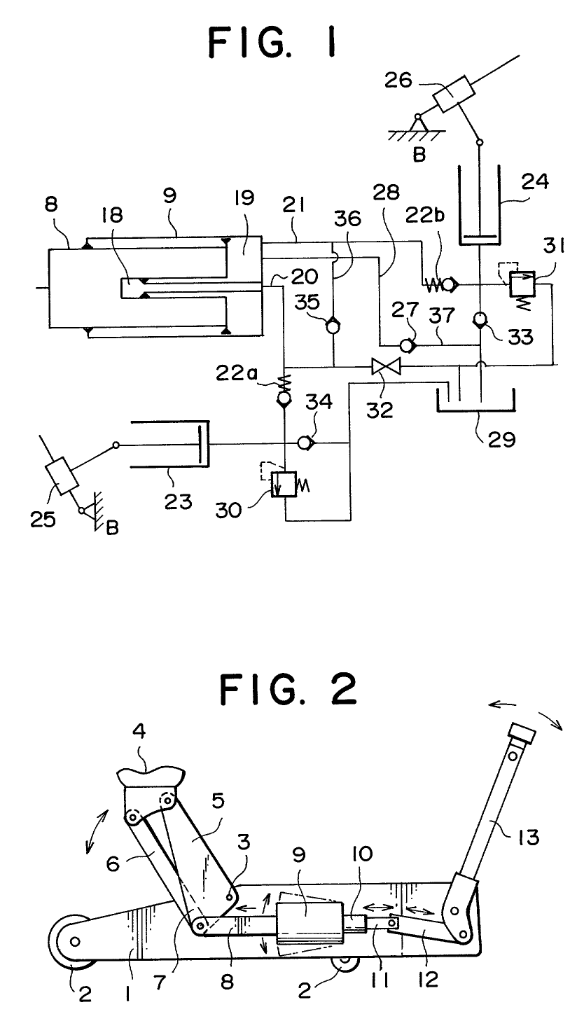

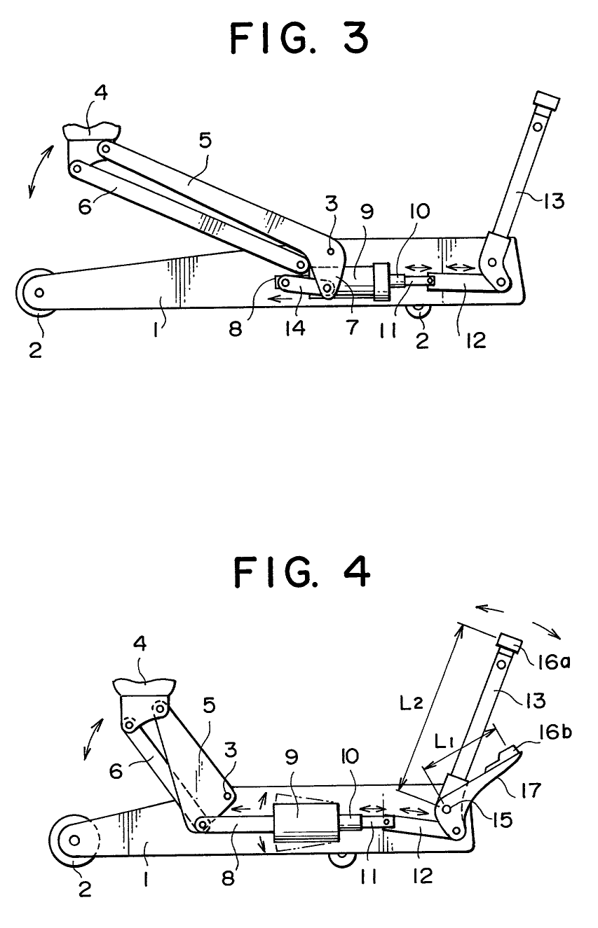

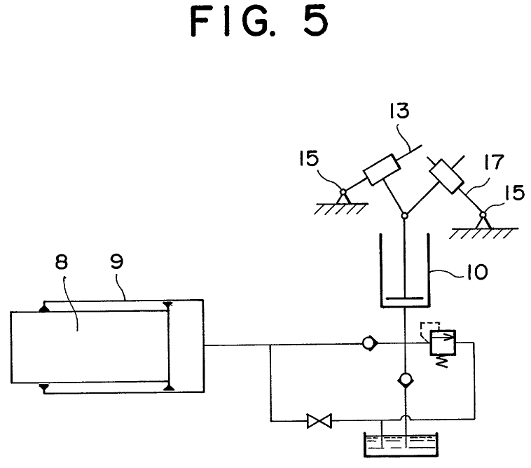

The present invention assumes a garage jack as shown in FIGS. 2 and 3, that is, a garage jack including, a movable frame 1 provided with wheels 2, an arm 5 pivotably supported at the frame 1 and having a support plate 4 at an end thereof, a hydraulic cylinder 9 for operating the arm 5 up-and-down, a pump cylinder 10 for supplying hydraulic fluid to the hydraulic cylinder 9 and a handle 13 for operating the pump cylinder 10.

As shown in FIG. 1, a hydraulic cylinder 9 includes a dual cylinder mechanism including a low pressure chamber 18 and a high pressure chamber 19. An inner cylinder is the low pressure chamber 18 of a small effective cross-sectional area relative to a piston 8 and an outer cylinder is the high pressure chamber 19 of a large effective cross-sectional area relative to the piston 8. A first hydraulic fluid channel 20 for supplying hydraulic fluid to the low pressure chamber 18 and a second hydraulic fluid channel 21 for supplying hydraulic fluid to the high pressure chamber 19 are provided independently. The first hydraulic fluid channel 20 is connected to a first pump cylinder 23 via a check valve 22a, and the second hydraulic fluid channel 21 is connected to a second pump cylinder 24 via a check valve 22b.

A foot-operated handle of short length from a pivot point 15 to an operating portion 16, that is, a foot-operated pedal 25, is provided at a bed B to operate the first pump cylinder 23 to supply hydraulic fluid to the low pressure chamber 18. On the other hand, a manually-operated handle of long length from a pivot point 15 to an operating portion 16, that is, a manually-operated handle 26, is similarly provided at the bed B to operate the second pump cylinder 24 to supply hydraulic fluid to the high pressure chamber 19.

Furthermore, a third hydraulic fluid channel 28 provided with a check valve 27 is provided between the high pressure chamber 19 and an oil tank 29, and in the case where the piston 8 is moved by hydraulic fluid fed to the low pressure chamber 18, hydraulic fluid may be drawn from an oil tank 29 so that a vacuum does not occur in the high pressure chamber 19. A fourth hydraulic fluid channel 36 provided with a check valve 35 for feeding hydraulic fluid of the second hydraulic fluid channel 21, that is, for feeding hydraulic fluid from the second pump cylinder 24, to the first hydraulic fluid channel 20 is provided between the first hydraulic fluid channel 20 and second hydraulic fluid channel 21. Accordingly, hydraulic fluid pumped by the second pump cylinder is simultaneously fed to both the high pressure chamber 19 and the low pressure chamber 18.

Moreover, safety valves 30 and 31 are provided to protect hydraulic circuits of the first and second hydraulic fluid channels 20, 21, respectively. A relief valve 32 for returning hydraulic fluid to the oil tank from the low and high pressure chamber 18, 19 and each hydraulic circuit is provided in a fifth hydraulic fluid channel 37 adjoining the oil tank 29 and connected to the first hydraulic fluid channel 20, the second hydraulic fluid channel 21 and the third hydraulic fluid channel 36. Also, check valves 33 and 34 prevent reverse flow of hydraulic fluid pumped by the first and second pump cylinders 23, 24.

In the above garage jack, when there is a substantially no-load operation, the piston 8 of the hydraulic cylinder 9 is operated at a high speed to raise the support plate to the jack point by operating the first pump cylinder 23 provided for the first hydraulic fluid channel 20 connected to the low pressure chamber 18 by means of the short foot-operated pedal 25. Also, when there is a load operation, hydraulic fluid is fed to both the high pressure chamber 19 and low pressure chamber 18 to operate the piston 8 of the hydraulic cylinder 9 in accordance with pressures corresponding to effective cross-sectional areas thereof by operating the second pump cylinder 24 provided for the second hydraulic fluid channel 21 connected to the high pressure chamber 19 by means of the long manually-operated handle 26, and it is possible to slowly raise an automotive vehicle.

Also, when the pressure inside the hydraulic cylinder 9 increases due to a large load, there is no difference in pressure between the high pressure chamber 19 and the low pressure chamber 18 because hydraulic fluid of the same pressure as that in the high pressure chamber 19 fills the low pressure chamber 18, and the inner cylinder disposed between the two chambers is not damaged, if it is made of an ordinary material. Incidentally, it is not necessary that the first and second pump cylinders 23, 24 be of the same diameter, and operation in a no-load condition is facilitated when the second pump cylinder 24 is of a small diameter.

According to the above mentioned garage jack, when there is a substantially no-load operation, hydraulic fluid is pumped to the low pressure chamber 18 of the inner cylinder of a small effective cross-sectional area relative to the piston by operating the foot-operated pedal and it is possible to rapidly raise the arm 5 provided with the support plate 4. Also, when there is a load operation, hydraulic fluid is pumped to the high pressure chamber 19 of the outer cylinder of a large effective cross-sectional area relative to the piston, as well as, to the low pressure chamber 18 of the inner cylinder of a small effective cross-sectional area by operating the manually-operated handle and it is possible to raise the arm at maximum output of the hydraulic cylinder 9. Accordingly, it is possible to eliminate inconvenience caused by the increased frequency of manual operation of the pump cylinder in the substantially no-load operation of raising the support plate from its lowest height to the vehicle jack point. Also, by designing separate first and second pump cylinders and operating handles thereof, it is possible to achieve optimal operability.

According to the present invention, the hydraulic cylinder includes the dual cylinder mechanism including the low pressure chamber and the high pressure chamber, the inner cylinder being the low pressure chamber of a small effective cross-sectional area relative to the piston and the outer cylinder being the high pressure chamber of a large effective cross-sectional area, and the first hydraulic fluid channel 20 for supplying hydraulic fluid to the low pressure chamber 18 and a second hydraulic fluid channel 21 for supplying hydraulic fluid to the high pressure chamber 19, provided independently. Thus, in raising the support plate from its lowest height to the jack point in the operation of lifting an automotive vehicle, hydraulic fluid is fed to the low pressure chamber and it is possible to quickly raise the arm provided with the support plate. Moreover, by designing separate first and second pump cylinders and operating handles thereof, it is possible to achieve optimal operability.

Many changes and modifications in the above embodiment of the invention can be carried out without departing from the scope thereof. Accordingly, the invention is intended to be limited only by the scope of the appended claims.

What is claimed is:

1. A garage jack comprising,
a movable frame provided with wheels, an arm pivotably supported at said frame and having a support plate at an end thereof, a hydraulic cylinder for operating said arm up-and-down, a pump cylinder for supplying hydraulic fluid to said hydraulic cylinder and a handle for operating said pump cylinder wherein,
said hydraulic cylinder comprises a dual cylinder mechanism comprising a low pressure chamber of a small effective cross-sectional area relative to a piston and a high pressure chamber of a large effective cross-sectional area, and a first pump cylinder and a first hydraulic fluid channel for feeding hydraulic fluid to said low pressure chamber and a second pump cylinder and a second hydraulic fluid channel for feeding hydraulic fluid to said high pressure chamber are provided independently.

2. A garage jack according to claim 1 wherein,
a fourth hydraulic fluid channel provided with a check valve and connected to said first hydraulic fluid channel of said first pump cylinder is divided from said second hydraulic fluid channel of said second pump cylinder in order to feed hydraulic fluid from said second pump cylinder to said low pressure chamber.

3. A garage jack according to claim 1 or claim 2 wherein,
a third hydraulic fluid channel provided with a check valve is provided between said high pressure chamber and an oil tank to prevent a vacuum in said high pressure chamber.

4. A garage jack according to any one of claims 1 to 3 wherein,
a hydraulic fluid channel provided with a relief valve is provided connected to said first and second hydraulic fluid channels to return hydraulic fluid to said oil tank.

5. A garage jack according to any one of claims 1 to 4 wherein,
said first pump cylinder is provided with a short foot-operated handle, and said second pump cylinder is provided with a long manually-operated handle.
